(19) United States
(12) Patent Application Publication
(10) Pub. No.: US 2026/0192368 A1
(43) Pub. Date: Jul. 9, 2026

(54) TOOL HOLDER FOR PRECISION HOLES ON THE SPINDLE CENTERLINE IN A LATHE

(71) Applicant: Kenneth Bruce Martin, Chino Valley, AZ (US)

(72) Inventor: Kenneth Bruce Martin, Chino Valley, AZ (US)

(21) Appl. No.: 19/011,995

(22) Filed: Jan. 7, 2025

(51) Int. Cl. B23B 29/28; B23B 3/16; B23B 25/06

(52) U.S. Cl. CPC B23B 29/285; B23B 3/162; B23B 25/06; B23B 2260/004; B23B 2270/12; B23B 2270/48

(57) ABSTRACT

A tool holding device for positioning a cutting tool on a centerline of a lathe is disclosed, including a cutting tool releasably attached to a cutting tool clamp. A main body is connected to the cutting tool clamp, wherein the main body being connectable to a lathe spindle. The cutting tool clamp is machined at an eccentric centerline of the main body to enable a centerline of the cutting tool to be positioned in-line with a centerline of the lathe spindle.

### CROSS REFERENCE TO RELATED APPLICATIONS

The present application claims priority to U.S. Provisional Application No. 63/464,899 filed May 8, 2023, titled “TOOL HOLDER FOR PRECISIONS HOLES ON SPINDLE CENTERLINE IN LATHES,” which is hereby incorporated by reference in its entirety.

### TECHNICAL FIELD

The embodiments disclosed herein generally relate to lathe tools and more particularly to a tool holder for precision holes on spindle a centerline in lathes.

### BACKGROUND

A lathe is a machine tool that rotates a workpiece about an axis of rotation to perform various operations such as cutting, sanding, knurling, drilling, deformation, facing, threading, and turning, using tools that are applied to the workpiece to create an object with symmetry about the axis of rotation. Most commonly, lathes are used in woodworking, metal working, and glass working, although many application exist.

Cutting tools which are held at the lathe centerline are held in a mounting pocket in the lathe turret. This mounting pocket is often not aligned with the centerline of the lathe spindle to which can adversely affect the function of the cutting tool and reduce the quality of the finished product. Methods supplied by the machine builder (if any) are known to be inadequate and require excessive time and effort by the operator in order to properly align the cutting tool with the lathe centerline.

### SUMMARY OF THE INVENTION

This summary is provided to introduce a variety of concepts in a simplified form that is further disclosed in the detailed description of the embodiments. This summary is not intended for determining the scope of the claimed subject matter.

A tool holding device for positioning a cutting tool on a centerline of a lathe is disclosed, including a cutting tool releasably attached to a cutting tool clamp. A main body is connected to the cutting tool clamp, wherein the main body being connectable to a lathe spindle. The cutting tool clamp is machined at an eccentric centerline of the main body to enable a centerline of the cutting tool to be positioned in-line with a centerline of the lathe spindle.

The tool holder assembly enables lathe operators (i.e., the user) to quickly clamp a cutting tool in a lathe precisely on the centerline of the lathe spindle. The tool holder assembly ensures the cutting tool is oriented on the same centerline axis as the lathe centerline axis to avoid malfunctioning of the tool and ensure higher quality of the final product being machined by the lathe. Historically, this process would require the lathe operator to spend significant time and effort insuring that the cutting tool was properly oriented.

Prior technology to hold tools that cut on centerline have no adjustment to shift the tool's centerline on the “Y” axis of the machine tool. This invention enables faster set-ups, and more precision alignment of cutting tools that function on the centerline of the lathe spindle. This includes drills, reamers, taps, boring tools, and the like. The ability of the assembly to bring the tool holding cavity centerline quickly and precisely to the lathe spindle centerline on the “Y” axis of the machine, and rigidly hold it on the centerline for all subsequent tools mounted in the pocket is not previously possible using devices in the prior art.

In one aspect, the assembly includes a cavity to receive a first end of the cutting tool.

In one aspect, the cavity is configured to clamp onto the cutting tool to secure the cutting tool in a fixed position within the cavity.

In one aspect, the cutting tool clamp is configured to provide a universal fit to a plurality of cutting tools.

In one aspect, engaging the main body to the lathe enables the efficient identification of the centerline of the lathe spindle.

In one aspect, the cutting tool clamp enables an operator to adjust the orientation of the cutting tool to shift the cutting tool onto the centerline of the lathe spindle.

In one aspect, a plurality of bolts retain the cutting tool in a fixed position on the centerline of the lathe spindle.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates a perspective view of the tool holder assembly for providing precision holes on the centerline of a lathe, according to some embodiments;

FIG. 1B illustrates a perspective view of the tool holder assembly for providing precision holes on the centerline of a lathe, according to some embodiments; and

FIG. 2A illustrates a perspective view of the tool holder assembly for providing precision holes on the centerline of a lathe, according to some embodiments; and

FIG. 2B illustrates a perspective view of the tool holder assembly for providing precision holes on the centerline of a lathe, according to some embodiments; and

FIG. 3A illustrates a perspective view of the tool holder assembly for providing precision holes on the centerline of a lathe, according to some embodiments; and

FIG. 3B illustrates a perspective view of the tool holder assembly for providing precision holes on the centerline of a lathe, according to some embodiments; and

FIG. 4 illustrates a flowchart of a method of utilizing the tool holder assembly, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a tool holder assembly for precision holes on the spindle centerline in lathes. The tool holder assembly enables lathe operators (i.e., the user) to quickly clamp a cutting tool in a lathe precisely on the centerline of the lathe spindle. The tool holder assembly ensures the cutting tool is oriented on the same centerline axis as the lathe centerline axis to avoid malfunctioning of the tool and ensure higher quality of the final product being machined by the lathe.

The portion of the tool holder that clamps the cutting tool is machined at an eccentric centerline from the main body of the tool holder allowing it to be rotated to bring the centerline of the cutting tool in line with the lathe spindle centerline on the “Y” axis of the machine tool.

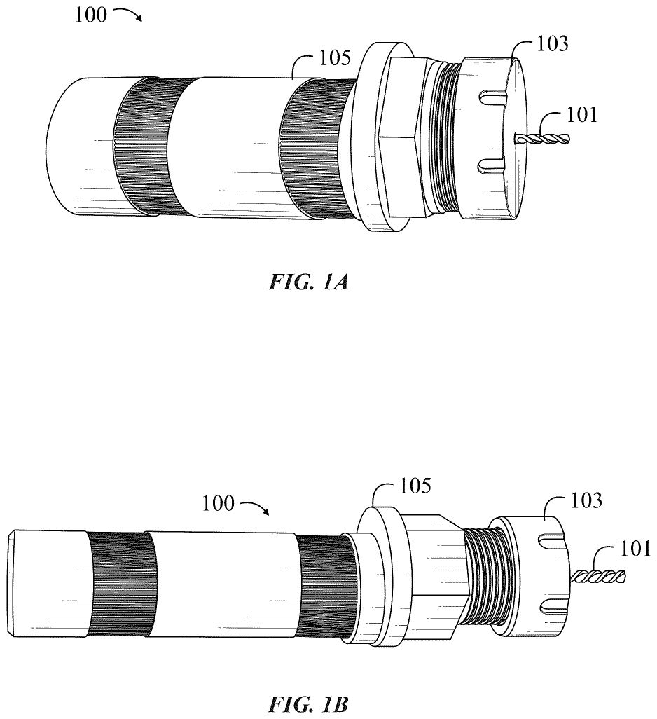

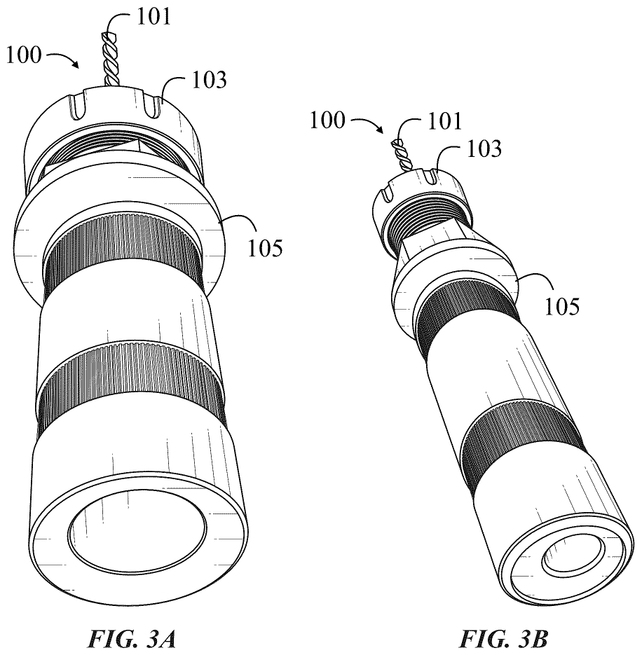

FIG. 1A-3B illustrate the tool holder assembly 100 used for holding a cutting tool 101 (or any working tool used with a lathe) on the centerline of a lathe. The cutting tool is releasably attached to a cutting tool clamp 103 which can increase or decrease in dimension to receive the cutting tool 101 and retain the cutting tool 101 in a fixed position during use. A main body 105 is connected to the cutting tool clamp 103. The cutting tool clamp 103 is machined at an eccentric centerline of the main body 105 to enable the centerline of the cutting tool to be positioned in-line (i.e., on the same axis) with the centerline of the lathe spindle.

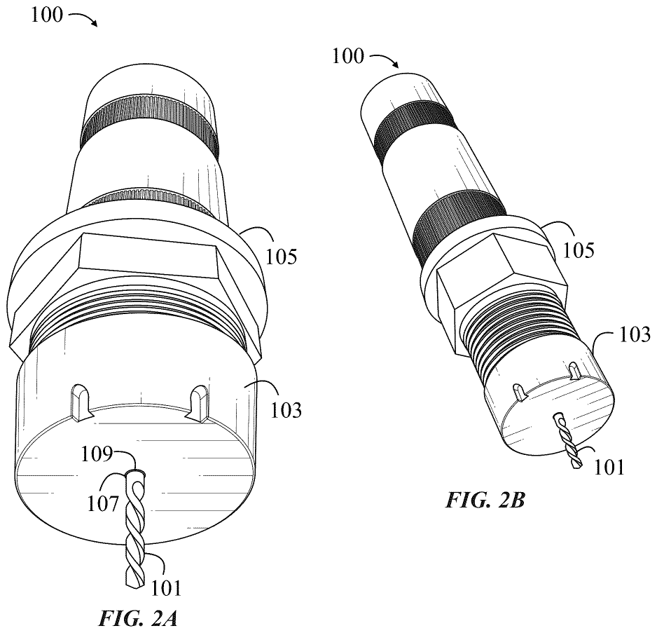

The cutting tool 101 includes a first end 107 (see FIG. 2A) which is at least partially received within a cavity 109 of the cutting tool clamp 103. The dimensions of the cavity 109 (see FIG. 2A) can be changed by the operator to accept various cutting tools 101 and to fittingly engage with the cutting tool 101. Further, the selective changing of the dimensions of the cavity 109 enable the operator to release the cutting tool 101 from the cavity 109.

In some embodiments, the cutting tool clamp 103 is capable of providing a universal fit with a various cutting tools which may be used during operation of the lathe. For example, the cutting tool 101 may be a tool used for cutting, sanding, knurling, drilling, deformation, facing, threading, and turning. In such, the term “cutting tool” as used herein may be used to refer to any working tool for performing a task with a lathe.

In some embodiments, the main body 105 is connectable to the lathe which enables the identification of the centerline of the lathe spindle. The cutting tool clamp 103 enables the operator to adjust the orientation of the cutting tool 101 using a wrench or other suitable tool to shift the cutting tool 101 onto the centerline of the lathe spindle by adjust the centerline of the tool holding pocket to the centerline of the lathe spindle. A plurality of bolts may be provided to retain the cutting tool in a fixed position on the centerline of the lathe. This may also be accomplished without the use of a wrench of the user is capable of performing the task by hand. The slots in the nut engage with the wrench for use in tightening the collet to hold the cutting tool.

In some embodiments, the cutting tool clamp 103 is releasably engaged with the main body 105 via threading or another releasable means of connection.

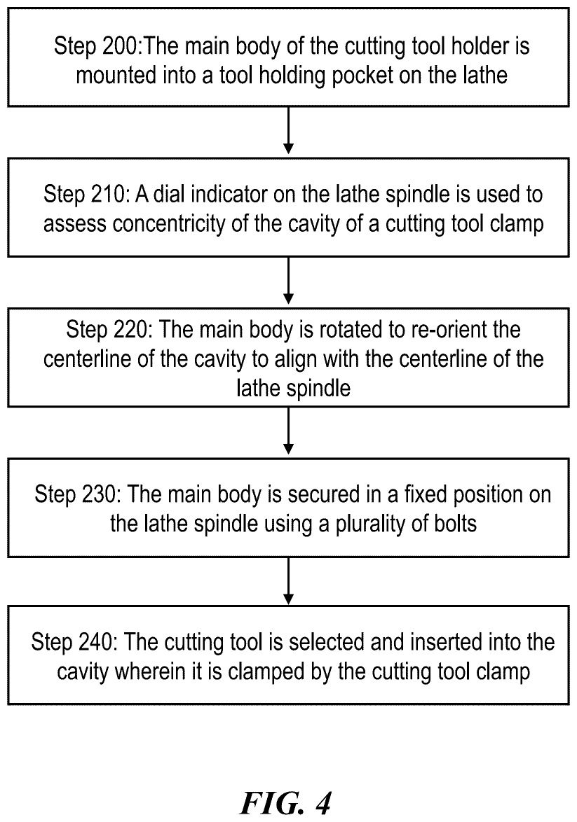

FIG. 4 illustrates a flowchart of a method of utilizing the tool holder assembly for identifying the centerline of a lathe spindle. In step 200, the main body of the cutting tool holder is mounted into a tool holding pocket on the lathe. In step 210, a dial indicator on the lathe spindle is utilized to assess concentricity of the cavity of a cutting tool clamp. In step 220, the main body is rotated to re-orient the centerline of the cavity to align the cavity centerline with the centerline of the lathe spindle. In step 230, the main body is secured in a fixed position on the lathe spindle using a plurality of bolts. In step 240, the cutting tool may then be selected by the operator and inserted into the cavity and tightened, using the cutting tool clamp, to retain the cutting tool in a fixed position.

In some embodiments, the main body may be rotated to shift the tool mounting centerline until it is exactly on the centerline of the lathe spindle in the “X & Y” axis. The operator can then record the mounting pocket's centerline position on the “X” axis of the machine and tighten each of the bolts retain the tool holder rigidly in position along the centerline of the lathe spindle. In such, any subsequent cutting tools mounted to the assembly tool will be oriented on the centerline of the lathe spindle, thus reducing the time which is required by prior art devices to re-orient the cutting tool for each subsequent tool.

In some embodiments, to replace the cutting tool with a subsequent cutting tool, the operator disconnects the cutting tool from the cutting tool clamp and positions a second (i.e., the subsequent) cutting tool within the cavity of the cutting tool clamp. The second cutting tool is then secured within the cavity of the cutting tool clamp to automatically ensure the position of the second cutting tool is along the centerline axis of the lathe spindle. The second cutting tool is then secured in position using the cutting tool clamp and is ready for use.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A tool holding device for positioning a cutting tool on a centerline of a lathe, the assembly comprising:
a cutting tool releasably attached to a cutting tool clamp; and
a main body connected to the cutting tool clamp, the main body being connectable to a lathe spindle,
wherein the cutting tool clamp is machined at an eccentric centerline of the main body to enable a centerline of the cutting tool to be positioned in-line with a centerline of the lathe spindle.

2. The tool holding device of claim 1, further comprising a cavity to receive a first end of the cutting tool.

3. The tool holding device of claim 2, wherein the cavity is configured to clamp onto the cutting tool to secure the cutting tool in a fixed position within the cavity.

4. The tool holding device of claim 1, wherein the cutting tool clamp is configured to provide a universal fit to a plurality of cutting tools.

5. The tool holding device of claim 1, wherein engaging the main body to the lathe enables the efficient identification of the centerline of the lathe spindle.

6. The tool holding device of claim 1, wherein the cutting tool clamp enables an operator to adjust the orientation of the cutting tool to shift the cutting tool onto the centerline of the lathe spindle.

7. The tool holding device of claim 1, wherein a plurality of bolts retain the cutting tool in a fixed position on the centerline of the lathe spindle.

8. A tool holding device for positioning a cutting tool on a centerline of a lathe, the assembly comprising:
a cutting tool comprising a first end and a second end, wherein the first end is positioned within a cutting tool clamp; and
a main body connected to the cutting tool clamp, the main body being connectable to a lathe spindle via a plurality of bolts, the plurality of bolts to enable the adjustment of the orientation of the cutting tool,
wherein the cutting tool clamp is machined at an eccentric centerline of the main body to enable a centerline of the cutting tool to be positioned in-line with a centerline of the lathe spindle.

9. The tool holding device of claim 8, wherein an operator utilizes a dial indicator on a lathe to assess the concentricity of the cavity of the cutting tool clamp.

10. The tool holding device of claim 9, wherein the main body is rotatable to shift the orientation of the centerline of the cutting tool to correspond to the centerline of the lathe spindle.

11. The tool holding device of claim 8, wherein the cutting tool clamp is configured to provide a universal fit to a plurality of cutting tools.

12. The tool holding device of claim 8, wherein the cutting tool is replaceable without detaching the main body from the lathe.

13. The tool holding device of claim 8, wherein the cutting tool clamp enables an operator to adjust the orientation of the cutting tool to shift the cutting tool onto the centerline of the lathe spindle.

14. The tool holding device of claim 8, wherein the cutting tool clamp is removably engaged with the main body.

15. A method for utilizing a tool holding device for identifying the centerline of a lathe spindle, the method comprising the steps of:
attaching a main body of a cutting tool holder to a lathe spindle;
utilizing a dial indicator on the lathe spindle to assess concentricity of a cavity of a cutting tool clamp;
rotating the main body to re-orient a centerline of the cavity to align the cavity of the cavity to the centerline of the lathe spindle;
securing the main body in a fixed position on the lathe spindle using a plurality of bolts; and
inserting a cutting tool into the cavity.

16. The method of claim 15, wherein the cavity is configured to clamp onto the cutting tool to secure the cutting tool in a fixed position within the cavity.

17. The method of claim 15, wherein the cutting tool clamp is configured to provide a universal fit to a plurality of cutting tools.

18. The method of claim 15, further comprising the step of: recording the position of the centerline of the lathe spindle using an X-axis coordinate and a Y-axis coordinate.

19. The method of claim 18, wherein the X-axis coordinate and the Y-axis coordinate correspond to the centerline of the cutting tool to provide an accurate means of ensuring the cutting tool remains in-plane with the centerline of the lathe spindle.

20. The method of claim 15, further comprising the steps of:
disconnecting the cutting tool from the cutting tool clamp;
positioning a second cutting tool within the cavity; and
securing the cutting tool within the cavity using the cutting tool clamp to efficiently replace the cutting tool with the second cutting tool, wherein securing the main body in the fixed position on the lathe spindle ensures the second cutting tool is arranged in-plane with the centerline of the lathe spindle.
